(19) United States
(12) Patent Application Publication
(10) Pub. No.: US 2025/0244649 A1
(43) Pub. Date: Jul. 31, 2025

(54) PROJECTION DEVICE

(71) Applicant: Coretronic Corporation, Hsin-Chu (TW)

(72) Inventors: YI-EN HSU, Hsin-Chu (TW); CHING-CHUAN WEI, Hsin-Chu (TW); CHI-MING YANG, Hsin-Chu (TW); JUI-CHI CHEN, Hsin-Chu (TW)

(21) Appl. No.: 19/004,535

(22) Filed: Dec. 30, 2024

(30) Foreign Application Priority Data
Jan. 26, 2024 (CN) 202410110201.0

(51) Int. Cl. G03B 21/16; G02B 27/00; G03B 21/14

(52) U.S. Cl. CPC G03B 21/16; G02B 27/0006; G03B 21/145

(57) ABSTRACT

A projection device includes a shell, an illumination system, an electrical connecting element, a light valve system, and a projection lens. The illumination system is disposed in the shell and provides an illumination beam. The light valve system includes a dustproof module and a light valve module. The dustproof module includes a frame and two transparent plates. An accommodation space is formed by the frame and the two transparent plates. The light valve module includes a light valve and an electrical connecting part. The light valve and the two transparent plates are located on a transmission path of the illumination beam, and the light valve converts the illumination beam into an image beam. One end of the electrical connecting part located in the accommodation space is electrically connected to the light valve, and the other end located outside the accommodation space is detachably electrically connected to the electrical connecting element.

### CROSS-REFERENCE TO RELATED APPLICATION

This application claims the priority benefit of China application (No. 202410110201.0), filed on Jan. 26, 2024. The entirety of the above-mentioned patent application is hereby incorporated by reference herein and made a part of this specification.

### TECHNICAL FIELD

The present disclosure relates to an imaging device, and more particularly to a projection device.

### BACKGROUND

The imaging method of a projection device is to project light onto a screen to form an image on the screen. Therefore, compared to a display that emits image light directly toward the user, the projection device typically occupies less space than the display.

Generally, the projection device is designed to be enclosed to accommodate a plurality of optical elements and prevent the optical elements from being contaminated by dust. However, because of the enclosed design, it not only limits the heat dissipation mechanism of the projection device but also increases the assembly and maintenance costs of the projection device.

The information disclosed in this “BACKGROUND” section is only for enhancement understanding of the background and therefore it may contain information that does not form the prior art that is already known to a person of ordinary skill in the art. Furthermore, the information disclosed in this “BACKGROUND” section does not mean that one or more problems to be solved by one or more embodiments of the disclosure were acknowledged by a person of ordinary skill in the art.

### SUMMARY

To achieve one or a portion of or all of the objectives or other objectives, a projection device in an embodiment of the present disclosure includes a shell, an illumination system, an electrical connecting element, a light valve system, and a projection lens. The illumination system is disposed in the shell and adapted to provide an illumination beam. The electrical connecting element is disposed in the shell. The light valve system includes a dustproof module and a light valve module. The dustproof module includes a frame and two transparent plates. The two transparent plates are respectively disposed at two opposite ends of the frame, and an accommodation space is formed by the frame and the two transparent plates. The light valve module includes a light valve and an electrical connecting part. The light valve is disposed in the accommodation space. The light valve and the two transparent plates are located on a transmission path of the illumination beam, and the light valve is adapted to convert the illumination beam into an image beam. The electrical connecting part passes through a through-hole of the frame. One end of the electrical connecting part located in the accommodation space is electrically connected to the light valve, and the other end of the electrical connecting part located outside the accommodation space is detachably electrically connected to the electrical connecting element. The projection lens is disposed on the transmission path of the image beam.

The projection device of the present disclosure adopts a light valve system having a dustproof module, where a light valve is disposed in an accommodation space of the dustproof module. Thus, the projection device of the present disclosure not only maintains the dustproof effect on the light valve but also allows for easier heat dissipation for other optical elements in the shell and a more flexible design of the heat dissipation mechanism in the projection device, thus improving the heat dissipation efficiency of the projection device. In addition, the light valve system can be separately detached from the shell and thus is easy to assemble, maintain, or replace, thereby prolonging the service life of the projection device and reducing the costs of the projection device.

Other objectives, features and advantages of the disclosure will be further understood from the further technological features disclosed by the embodiments of the disclosure wherein there are shown and described preferred embodiments of this disclosure, simply by way of illustration of modes best suited to carry out the disclosure.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic cross-sectional view of a projection device according to an embodiment of the present disclosure;

FIG. 2 is a schematic three-dimensional diagram of a light valve system in FIG. 1;

FIG. 3 is a schematic cross-sectional view of a light valve system, taken along the line A1-A1 in FIG. 2;

FIG. 4 is a schematic local cross-sectional view of a projection device according to another embodiment of the present disclosure;

FIG. 5 is a schematic cross-sectional view of a light valve system of a projection device according to another embodiment of the present disclosure; and

FIG. 6 is a schematic cross-sectional view of a projection device according to another embodiment of the present disclosure.

### DETAILED DESCRIPTION OF PREFERRED EMBODIMENTS

In the following detailed description of the preferred embodiments, reference is made to the accompanying drawings which form a part hereof, and in which is shown by way of illustration specific embodiments in which the disclosure may be practiced. In this regard, directional terminology, such as “top”, “bottom”, “front”, “back”, etc., is used with reference to the orientation of the Figure(s) being described. The components of the disclosure can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the disclosure. Also, it is to be understood that the phraseology and terminology used herein are for the purpose of description and should not be regarded as limiting. The use of “including”, “comprising”, or “having” and variations thereof herein is meant to encompass the items listed thereafter and equivalents thereof as well as additional items. Unless limited otherwise, the terms “connected”, “coupled”, and “mounted” and variations thereof herein are used broadly and encompass direct and indirect connections, couplings, and mountings. Similarly, the terms “facing”, “faces”, and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

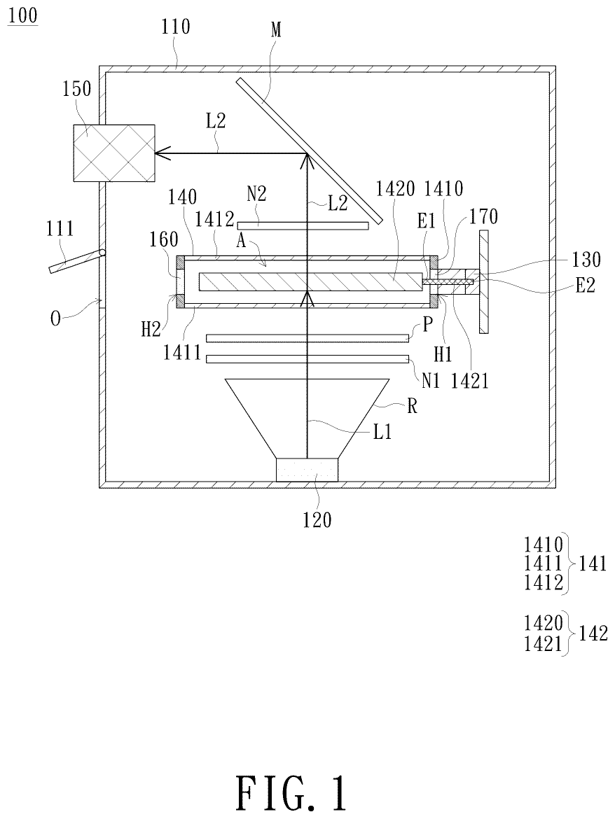

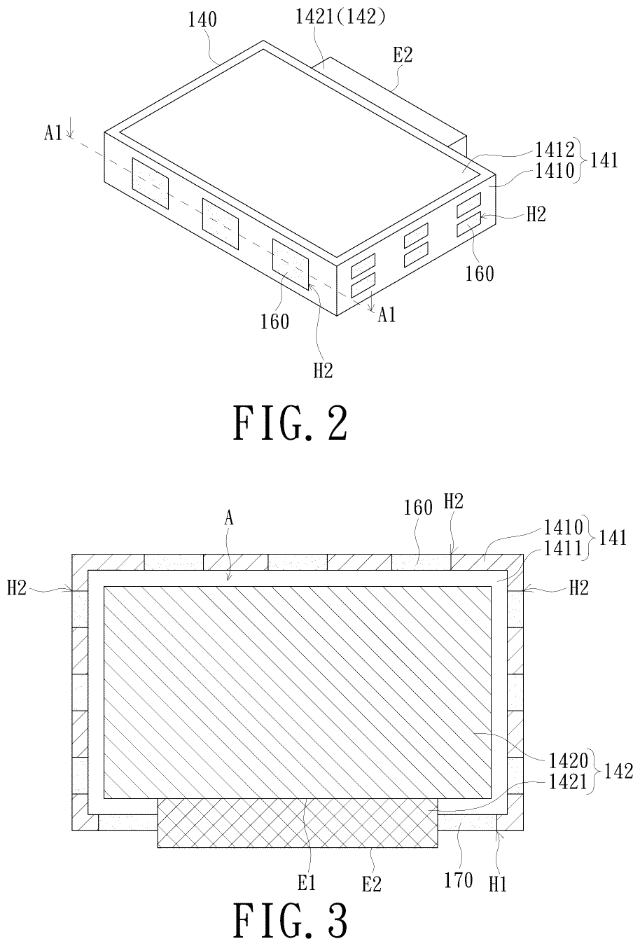

FIG. 1 is a schematic cross-sectional view of a projection device according to an embodiment of the present disclosure. FIG. 2 is a schematic three-dimensional diagram of a light valve system in FIG. 1. FIG. 3 is a schematic cross-sectional view of a light valve system, taken along the line A1-A1 in FIG. 2. Referring to FIGS. 1 to 3 first, the projection device 100 includes a shell 110, an illumination system 120, an electrical connecting element 130, a light valve system 140, and a projection lens 150. The illumination system 120 is disposed in the shell 110 and adapted to provide an illumination beam L1. The electrical connecting element 130 is disposed in the shell 110. The light valve system 140 includes a dustproof module 141 and a light valve module 142. The dustproof module 141 includes a frame 1410 and transparent plates 1411 (also shown in FIGS. 3) and 1412. The transparent plates 1411 and 1412 are respectively disposed at two opposite ends of the frame 1410. An accommodation space A is formed by the frame 1410 and the transparent plates 1411 and 1412. The light valve module 142 includes a light valve 1420 and an electrical connecting part 1421. The light valve 1420 is disposed in the accommodation space A. The light valve 1420 and the transparent plates 1411 and 1412 are located on a transmission path of the illumination beam L1, and the light valve 1420 is adapted to convert the illumination beam L1 into an image beam L2. The electrical connecting part 1421 passes through a through-hole H1 of the frame 1410. One end E1 of the electrical connecting part 1421 located in the accommodation space A is electrically connected to the light valve 1420, and the other end E2 (also shown in FIG. 2) of the electrical connecting part 1421 located outside the accommodation space A is detachably electrically connected to the electrical connecting element 130. The projection lens 150 is disposed on a transmission path of the image beam L2.

The light valve system 140 can receive power via the electrical connecting element 130 and may be disassembled from the electrical connecting element 130. In other words, the light valve system 140 may be individually removed from the shell 110 and thus has the advantage of easy assembly, maintenance, or replacement. In this embodiment, the light valve 1420 includes, for example, a liquid crystal panel, and the liquid crystal panel receives power via the electrical connecting part 1421 and the electrical connecting element 130 which are electrically connected to each other. In addition, the dustproof module 141 can allow the illumination beam L1 to be incident onto the light valve 1420 and can prevent dust from entering the accommodation space A, thus preventing the light valve 1420 from being contaminated. Specifically, the light valve 1420 may be disposed between the transparent plates 1411 and 1412, wherein the transparent plate 1411 is located on a transmission path of the illumination beam L1 and allows the illumination beam L1 to pass through and be incident onto the light valve 1420. Furthermore, after the illumination beam L1 is converted by the light valve 1420 into the image beam L2, the image beam L2 can pass through the transparent plate 1412 and exit from the dustproof module 141. In this embodiment, the transparent plates 1411 and 1412 are both, for example, flat plate-shaped. In addition, the material of the transparent plates 1411 and 1412 may include glass, but the present disclosure is not limited thereto.

Referring to FIGS. 2 and 3, the light valve system 140 in this embodiment further includes, for example, a dustproof member 160 (also shown in FIG. 1). The frame 1410 may have at least one heat dissipation hole H2, and a plurality of heat dissipation holes H2 are provided in this embodiment as an example. The dustproof member 160 is disposed at the frame 1410 and covers the heat dissipation holes H2. Therefore, the airflow can enter or exit from the dustproof module 141 through the heat dissipation holes H2, and the dustproof member 160 can maintain the dustproof effect of the dustproof module 141 on the light valve 1420, thus improving the heat dissipation efficiency of the light valve 1420. In this embodiment, the dustproof member 160 may be disposed in the heat dissipation hole H2, but other embodiments are not limited thereto. For example, in an embodiment, the dustproof member 160 may be disposed on an inner side surface or outer side surface of the frame 1410 and covers the heat dissipation hole H2. The dustproof member 160 in this embodiment includes, for example, a filter, such that it is easier for the airflow to enter or exit from the dustproof module 141 via the heat dissipation hole H2, thus improving the heat dissipation efficiency of the light valve 1420. Incidentally, the heat dissipation holes H2 may be located on at least one side of the frame 1410. This embodiment takes the heat dissipation holes H2 being located on three sides of the frame 1410 as an example, but other embodiments are not limited thereto. In addition, the present disclosure does not limit the shape and quantity of the heat dissipation holes H2.

Still referring to FIGS. 1 and 3, in this embodiment, the light valve system 140 further includes, for example, a dust-blocking member 170, and the dust-blocking member 170 is disposed between the electrical connecting part 1421 and the through-hole H1. In other words, the dust-blocking member 170 may be sealed between the frame 1410 and the electrical connecting part 1421 and cover the through-hole H1, thus preventing dust from entering the dustproof module 141 via the through-hole H1. The dust-blocking member 170 is fixed, for example, in the through-hole H1 and can allow the end E2 of the electrical connecting part 1421 to extend out of the through-hole H1. Similarly, in an embodiment, the dust-blocking member 170 may be fixed on the inner side surface or outer side surface of the frame 1410. Similarly, the dust-blocking member 170 in this embodiment may include a filter, allowing the airflow to enter or exit from the dustproof module 141 more easily via the through-hole H1. It can be understood that the present disclosure does not limit the shape of the through-hole H1.

Still referring to FIG. 1, in this embodiment, the electrical connecting element 130 may be fixed to a mechanism member in the shell 110. The electrical connecting element 130 may include a card edge connector. The end E2 of the electrical connecting part 1421 located outside the accommodation space A includes, for example, a gold finger detachably electrically connected to the card edge connector, wherein the card edge connector may be, for example, a card slot or others. Further, the gold finger is electrically connected to the light valve 1420, and the light valve 1420 is electrically connected to the card edge connector when the gold finger is inserted into the card edge connector.

The shell 110 may have a mounting opening O, and the light valve system 140 is detachably fixed to the electrical connecting element 130 via the mounting opening O. In this way, the light valve system 140 may be placed in or removed from the shell 110 via the mounting opening O and thus is easier to assemble or disassemble. Further, the shell 110 may include a cover 111. The cover 111 is adapted to shield or expose the mounting opening O to improve the dustproof function of the shell 110. For example, the cover 111 may include a pivot cover. In an embodiment, the cover 111 may include a slidable cover. In another embodiment, the shell 110 may not be provided with the mounting opening O and the cover 111, and the light valve system 140 can be removed by disassembling the shell 110.

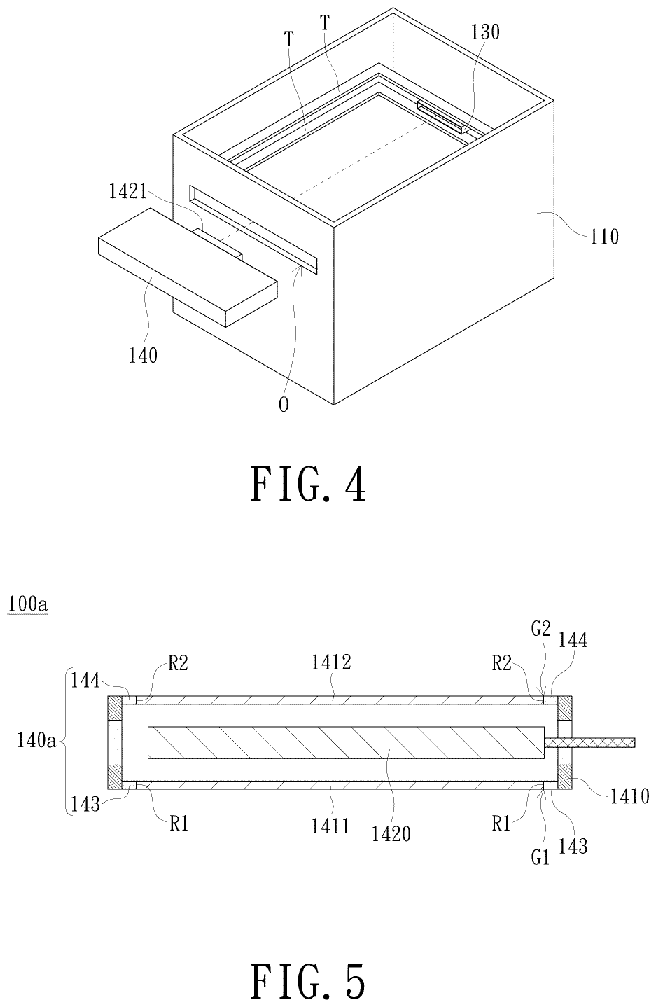

FIG. 4 is a schematic local cross-sectional view of a projection device according to another embodiment of the present disclosure. Referring to FIG. 4, incidentally, in an embodiment, a track T corresponding to the mounting opening O may be disposed in the shell 110. The light valve system 140 may be disposed on the track T via the mounting opening O and move along the track T until the electrical connecting part 1421 is fixed to and electrically connected to the electrical connecting element 130. In this way, the light valve system 140 can be mounted in the shell 110. On the contrary, the light valve system 140 can be removed via the mounting opening O along the track T, such that the light valve system 140 is disassembled from the shell 110.

Still referring to FIG. 1, in this embodiment, the illumination system 120 includes, for example, a light-emitting diode (LED), and the light-emitting diode may generate the illumination beam L1. Specifically, there may be one or more light-emitting diodes. For example, when there is a plurality of light-emitting diodes, the light-emitting diodes may be arranged as a matrix. In an embodiment, the illumination system 120 may include a laser diode (LD), and the laser diode may generate the illumination beam L1.

The projection lens 150 in this embodiment may be sleeved at the shell 110. The projection lens 150 includes, for example, one or more optical lenses, and the refractive indices of the optical lenses may be the same or different from each other. For example, the optical lenses may include various non-planar lenses such as a biconcave lens, a biconvex lens, a concavo-convex lens, a convexo-concave lens, a plano-convex lens, and a plano-concave lens, or any combination thereof. In an embodiment, the projection lens 150 may include a planar optical lens, and the present disclosure does not limit the specific structure of the projection lens 150.

Compared to the prior art, the projection device 100 in this embodiment adopts the light valve system 140 having the dustproof module 141 and the light valve 1420 is disposed in the accommodation space A of the dustproof module 141, thus, the projection device 100 of this embodiment not only maintains the dustproof effect on the light valve 1420 but also allows for easier heat dissipation for other optical elements in the shell 110 and more flexible design of the heat dissipation mechanism in the projection device, thus improving the heat dissipation efficiency of the projection device 100. In addition, the light valve system 140 can be separately detached from the shell 110 and thus is easy to assemble, maintain, or replace, thereby prolonging the service life of the projection device 100 and reducing the costs of the projection device 100.

Incidentally, an integration rod R, a reflective polarizer P, a reflector M, and lenses N1 and N2 may be provided in the shell 110. Specifically, the integration rod R may be disposed on the transmission path of the illumination beam L1. The lens N1 and the reflective polarizer P may be disposed between the integration rod R and the light valve system 140 to allow the illumination beam L1 to pass therethrough and be incident onto the light valve system 140. The lens N2 is disposed on the transmission path of the image beam L2. The reflector M can reflect the image beam L2 that exits from the lens N2 to the projection lens 150. In this embodiment, the lenses N1 and N2 include, for example, Fresnel lenses, but the present disclosure is not limited thereto. It can be understood that the structures and positions of the optical elements such as the integration rod R, the reflective polarizer P, the reflector M, and the lenses N1 and N2 shown in FIG. 1 are only examples and do not limit the present disclosure.

FIG. 5 is a schematic cross-sectional view of a light valve system of a projection device according to another embodiment of the present disclosure. The structure and advantage of a projection device 100a in this embodiment are similar to those in the embodiment in FIG. 1, and the following describes only the difference. Referring to FIG. 5, the light valve system 140a may further include sealing members 143 and 144. The sealing member 143 is disposed between an edge R1 of the transparent plate 1411 and the frame 1410, and the sealing member 144 is disposed between an edge R2 of the transparent plate 1412 and the frame 1410. Therefore, the sealing member 143 can seal the gap G1 between the transparent plate 1411 and the frame 1410, and the sealing member 144 can seal the gap G2 between the transparent plate 1412 and the frame 1410, thus improving the dustproof effect of the light valve 1420. Incidentally, the transparent plate 1411 may be detachably fixed at the frame 1410 via the sealing member 143, and the transparent plate 1412 may be detachably fixed at the frame 1410 via the sealing member 144. In this way, the transparent plates 1411 and 1412 can be respectively disassembled or replaced from the frame 1410, thus prolonging the service life of the light valve system 140. For example, the sealing members 143 and 144 in this embodiment may include double-sided tapes. Specifically, the transparent plates 1411 and 1412 can be adhered to the frame 1410 via the double-sided tapes, and the double-sided tapes can fill up the gaps G1 and G2. In an embodiment, the sealing members 143 and 144 include, for example, mechanism members. The transparent plates 1411 and 1412 can be fixed to the frame 1410 via the mechanism members, and the mechanism members can be embedded in the gaps G1 and G2.

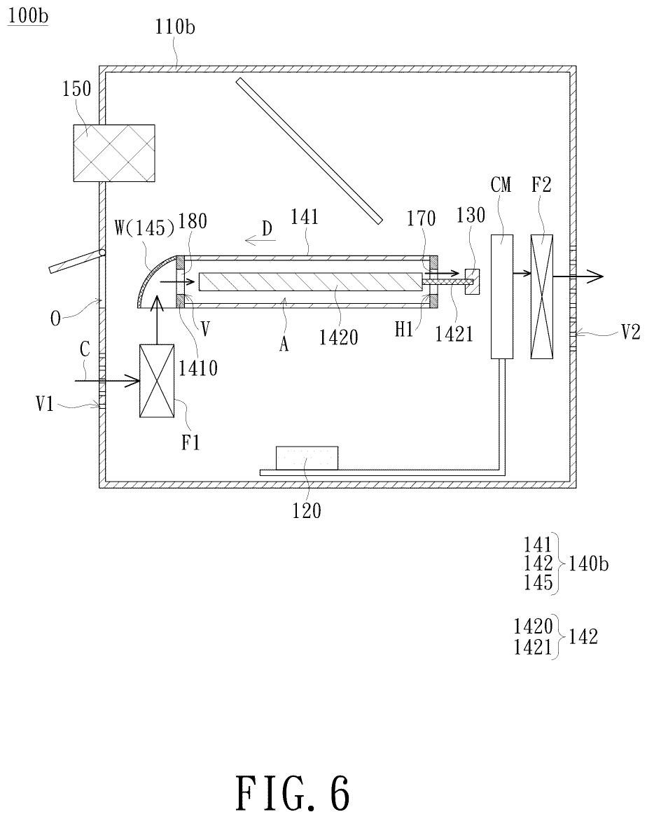

FIG. 6 is a schematic cross-sectional view of a projection device according to another embodiment of the present disclosure. The structure and advantage of a projection device 100b in this embodiment are similar to those in the embodiment in FIG. 1, and the following describes only the difference. Referring to FIG. 6, the projection device 100b may further include a fan F1, and the fan F1 is disposed in a shell 110b. A light valve system 140b further includes, for example, an air guide member 145. The frame 1410 further includes at least one air intake vent V, and one air intake vent V is used as an example in FIG. 6. The air guide member 145 is disposed on a side of the frame 1410 away from the light valve module 142, and the air guide member 145 is adjacent to the air intake vent V. The fan F1 is adapted to generate an airflow C passing through the air guide member 145 and the at least one air intake vent V. Specifically, the air guide member 145 may guide the airflow C to enter the dustproof module 141 from the air intake vent V, such that the airflow C flows through the light valve 1420 and flows out of the dustproof module 141 via the through-hole H1, thus further improving the heat dissipation efficiency of the light valve 1420.

In this embodiment, the light valve system 140b may further include a dustproof member 180. The dustproof member 180 is disposed at the frame 1410 and covers the air intake vent V to further improve the dustproof effect of the light valve 1420. For example, the dustproof member 160 shown in FIG. 2 may serve as the dustproof member 180 in FIG. 6, and the dustproof members 160 and 180 have the substantially same features, and no redundant detail is to be given herein. Similarly, the part in the heat dissipation hole H2 in FIG. 2 corresponding to the through-hole H1 may serve as the air intake vent V in FIG. 6, but the present disclosure does not limit the specific features of the air intake vent V. The dust-blocking member 170 in this embodiment may include a filter, allowing the airflow C to pass through the dust-blocking member 170 more easily and flow out of the dustproof module 141. Incidentally, the fan F1 includes, for example, a blowing fan, but the present disclosure is not limited thereto. Moreover, the shell 110b may be provided with a vent V1 corresponding to the fan F1 for the airflow C to enter the shell 110b.

In this embodiment, the air guide member 145 includes, for example, an air-blocking wall W. The air-blocking wall W is adapted to guide the airflow C generated by the fan F1 to the air intake vent V, and the air-blocking wall W shields the air intake vent V in a direction D of an orthographic projection of the air intake vent V. For example, the shape of the air-blocking wall W may be arc-shaped, such that the airflow C can be more quickly guided into the dustproof module 141, thus further improving the heat dissipation efficiency of the light valve 1420. Incidentally, the air guide member 145 can be fixed to an edge of the air intake vent V, and the air guide member 145 and the fan F1 are located on two opposite sides of the air intake vent V to guide more airflow C to enter the dustproof module 141. In addition, the air guide member 145 is located between the air intake vent V and the mounting opening O. The air guide member 145 can shield the mounting opening O in the direction D of the orthographic projection of the air intake vent V. In this way, when the airflow C generated by the fan F1 flows between the air guide member 145 and the air intake vent V, the airflow C can flow into the accommodation space A via the air intake vent V to the largest extent. In other words, the excessive amount of the airflow C can be prevented from flowing out of the shell 110b via the mounting opening O, thereby guiding much more of the airflow C to enter the dustproof module 141.

The air guide member 145 and the electrical connecting part 1421 may be respectively disposed on two opposite sides of the frame 1410. Specifically, the air guide member 145 may face the mounting opening O and serve as a handle of the light valve system 140 for use. In this way, when the light valve system 140 is fixed to the electrical connecting element 130, the user can hold the air guide member 145 via the mounting opening O to take out the light valve system 140 from the shell 110b via the air guide member 145, allowing for easier disassembly of the light valve system 140 from the shell 110b. In addition, because the air guide member 145 can serve as the handle of the light valve system 140, the light valve system 140 also has the advantage of a simple structure.

Incidentally, the projection device 100b may be provided with a heat dissipation module CM and a fan F2 to dissipate heat from the illumination system 120. Specifically, the heat dissipation module CM may be connected to the illumination system 120 to receive the heat generated by the illumination system 120. The fan F2 can dissipate heat from the heat dissipation module CM. Further, the heat dissipation module CM includes, for example, a plurality of fins, and the fan F2 can guide the airflow C to pass through these fins. Similarly, the shell 110b may be provided with a vent V2 corresponding to the fan F2 for the airflow C to flow out of the shell 110b. The vent V2 has substantially the same features and effects as the vent V1, and no redundant detail is to be given herein. It can be understood that the flowing direction of the airflow C is not limited to FIG. 6. For example, in an embodiment, the airflow C may be drawn into the shell 110b via the vent V2 by the fan F2 and flow out of the shell 110b via the vent V1 by the fan F1.

In summary, the projection device of the present disclosure includes a light valve system with a dustproof module, and the light valve is disposed in the accommodation space of the dustproof module. Thus, the projection device of the embodiments of the present disclosure at least has one of the following advantages. The projection device of the present disclosure not only maintains the dustproof effect on the light valve but also allows for easier heat dissipation for the other optical elements in the shell and a more flexible design of the heat dissipation mechanism in the projection device. In addition, the light valve system can be separately detached from the shell and thus is easy to assemble, maintain, or replace, thereby prolonging the service life of the projection device and reducing the costs of the projection device.

The foregoing description of the preferred embodiment of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure” is not necessary limited the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the disclosure as defined by the following claims. Moreover, no element and component in the disclosure is intended to be dedicated to the public regardless of whether the element or component is explicitly recited in the following claims.

What is claimed is:

1. A projection device, comprising:
a shell;
an illumination system, disposed in the shell and adapted to provide an illumination beam;
an electrical connecting element, disposed in the shell;
a light valve system, comprising:
a dustproof module, comprising a frame and two transparent plates, wherein the two transparent plates are respectively disposed at two opposite ends of the frame, and an accommodation space is formed by the frame and the two transparent plates; and
a light valve module, comprising a light valve and an electrical connecting part, wherein the light valve is disposed in the accommodation space, the light valve and the two transparent plates are located on a transmission path of the illumination beam, the light valve is adapted to convert the illumination beam into an image beam, the electrical connecting part is disposed to pass through a through-hole of the frame, one end of the electrical connecting part located in the accommodation space is electrically connected to the light valve, and the other end of the electrical connecting part located outside the accommodation space is detachably electrically connected to the electrical connecting element; and
a projection lens, disposed on a transmission path of the image beam.

2. The projection device according to claim 1, wherein the light valve system further comprises a dustproof member, the frame has at least one heat dissipation hole, and the dustproof member is disposed at the frame and covers the at least one heat dissipation hole.

3. The projection device according to claim 1, wherein the light valve system further comprises two sealing members, one of the two sealing members is disposed between an edge of one of the two transparent plates and the frame, and the other of the two sealing members is disposed between an edge of the other of the two transparent plates and the frame.

4. The projection device according to claim 1, wherein the light valve system further comprises a dust-blocking member disposed between the electrical connecting part and the through-hole.

5. The projection device according to claim 1, wherein the electrical connecting element comprises a card edge connector, and the other end of the electrical connecting part located outside the accommodation space comprises a gold finger detachably electrically connected to the card edge connector.

6. The projection device according to claim 1, further comprising a fan, wherein the fan is disposed in the shell, the light valve system further comprises an air guide member, the frame further comprises at least one air intake vent, the air guide member is disposed on a side of the frame away from the light valve module, the air guide member is adjacent to the at least one air intake vent, and the fan is adapted to generate an airflow passing through the air guide member and the at least one air intake vent.

7. The projection device according to claim 6, wherein the light valve system further comprises a dustproof member, and the dustproof member is disposed at the frame and covers the at least one air intake vent.

8. The projection device according to claim 6, wherein the air guide member and the electrical connecting part are respectively located on two opposite sides of the frame.

9. The projection device according to claim 6, wherein the air guide member comprises an air-blocking wall, the air-blocking wall is adapted to guide the airflow generated by the fan to the at least one air intake vent, and the air-blocking wall shields the at least one air intake vent in a direction of an orthographic projection of the at least one air intake vent.

10. The projection device according to claim 1, wherein the shell has a mounting opening, and the light valve system is detachably fixed to the electrical connecting element via the mounting opening.

11. The projection device according to claim 10, wherein the shell comprises a cover, and the cover is adapted to shield or expose the mounting opening.
